(19) United States
(12) Patent Application Publication
(10) Pub. No.: US 2024/0287735 A1
(43) Pub. Date: Aug. 29, 2024

(54) POLYMER COMPOSITION FOR COATING A POLYOLEFIN FABRIC SUBSTRATE

(71) Applicant: BOREALIS AG, Vienna (AT)

(72) Inventors: Tuan Anh TRAN, Linz (AT); Mirela Tury PASTORINI, Linz (AT); Johan DEFOER, Mechelen (BE)

(21) Appl. No.: 17/768,960

(22) PCT Filed: Oct. 15, 2020
(86) PCT No.: PCT/EP2020/079013

§ 371 Date: Apr. 14, 2022

(30) Foreign Application Priority Data
Oct. 15, 2019 (EP) 19203332.2

(51) Int. Cl. D06M 15/227

(52) U.S. Cl. CPC D06M 15/227; D10B 2321/02

(57) ABSTRACT

The present invention relates to a polymer composition suitable for coating a polyolefin fabric substrate comprising the following components: A) 5 to 35 wt.-% based on the overall weight of the polymer composition of a recycled polyolefin fabric substrate; wherein said fabric substrate is coated with a polyolefin composition comprising the following components: a1) an ethylene based plastomer with a density determined according to ISO 1183-1 in the range of 0.857 to 0.915 g/cm³ and a MFR₂ (190° C. 2.16 kg) determined according to ISO 1133 in the range of 0.5 to 30 g/10 min; and a2) a propylene based plastomer with a density determined according to ISO 1183-1 in the range of 0.850 to 0.910 g/cm³ and a MFR₂ (230° C. 2.16 kg) determined according to ISO 1133 in the range of 0.01 to 30 g/10 min; B) 65 to 95 wt.-% based on the overall weight of the polymer composition of a virgin polyolefin composition comprising the following components: b1) an ethylene based plastomer with a density determined according to ISO 1183-1 in the range of 0.857 to 0.915 g/cm³ and a MFR₂ (190° C. 2.16 kg) determined according to ISO 1133 in the range of 0.5 to 30 g/10 min; and b2) a propylene based plastomer with a density determined according to ISO 1183-1 in the range of 0.850 to 0.910 g/cm³ and a MFR₂ (230° C. 2.16 kg) determined according to ISO 1133 in the range of 0.01 to 30 g/10 min. Furthermore, the present invention relates to use of component A) for coating a virgin or recycled polyolefin fabric substrate, to a process for coating a polyolefin fabric substrate, to a polyolefin fabric substrate coated with the composition according to the invention and to an article comprising at least one component formed from the coated polyolefin substrate.

The present invention relates to a polymer composition suitable for coating a polyolefin fabric substrate comprising at least component A) being a specific recycled coated polyolefin fabric substrate and component B) being a virgin polyolefin composition. In addition, the present invention refers to a process for preparing said composition, to a process for coating a polyolefin fabric substrate with said composition, to a polyolefin fabric substrate coated with the polymer composition according to the invention and to an article comprising at least one component formed from the coated polyolefin fabric substrate.

### BACKGROUND OF INVENTION

Polymer coated textile materials are used in a wide range of applications such as carpets, mattresses, pillows and seat upholstery for office furniture, car interiors etc. Such materials desirably have a good degree of softness as well as attractive abrasion and UV resistance properties.

In the market nowadays, polymer coated textile materials are made of various non-polyolefin materials, such as polyurethane (PU), polyvinyl chloride (PVC) and ethylene vinyl acetate (EVA). From sustainability perspective, these materials are challenging, if not impossible, to recycle. Furthermore, when mixed together, it is mostly not possible to separate them properly when submitted to sorting for recycling.

Nevertheless, for sustainability reasons there is an urgent need for polymer coated textile fabrics having a coating at least partly made of recycled materials. On the other hand, the use of recycled materials must not impair the properties to such an extent that the materials are no longer suitable for the desired application.

US 2008/0299853 A1 describes a three layer coated fabric which has a bottom backing layer, a top coating layer and a middle coating layer that contains recycled coated fabric material. All of the constituent parts of coated fabrics being recycled are included in the middle layer. The middle layer also sometimes contains other materials that can blend with the recycled coated fabrics or other recycled post-consumer materials. The three layer coated fabric is manufactured by transforming the recycled coated fabrics and other materials into a form that can be used to create the middle layer. With regard to the type of usable materials the document is very general and polyolefins are not mentioned. In addition, the disclosed coated fabric is limited with regard to the position of the coating layer containing the recycled material, the recycled material has to be present in the middle layer of the coating. In addition, the document does not contain any working examples and fails to demonstrate that a coated fabric with acceptable properties can be obtained.

Fabric substrates based on polyolefins are already known in the art. WO 2006/109319 A1 relates to a process for manufacturing of protective covers comprising a polypropylene fabric coated or laminated with a thermoplastic polyolefin compound. However, the document is silent on recycling aspects.

Based on this, it was the objective of the present invention to provide a polymer composition suitable for coating a polyolefin fabric substrate comprising recycled materials based on materials that are feasible to be sorted out, separated and collected for the next conversion life(s). In addition, it was the objective of the present invention to provide a polymer composition suitable for coating a polyolefin fabric substrate comprising recycled materials, which also allows shows good mechanical properties, especially a good stiffness expressed by the tensile properties. The material should also retain flame retardance.

### SUMMARY OF INVENTION

These objects have been solved by the polymer composition suitable for coating a polyolefin fabric substrate comprising the following components:
A) 5 to 35 wt.-% based on the overall weight of the polymer composition of a recycled coated polyolefin fabric substrate; wherein said fabric substrate is coated with a polyolefin composition comprising the following components:
   a1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
   a2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min;
B) 65 to 95 wt.-% based on the overall weight of the polymer composition of a virgin polyolefin composition comprising the following components:
   b1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
   b2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min;

with the proviso that components A) and B) add up to 100 wt.-%.

In particular, the invention provides a polymer composition suitable for coating a polyolefin fabric substrate comprising the following components:
A) 5 to 35 wt.-% based on the overall weight of the polymer composition of a recycled coated polyolefin fabric substrate; wherein said fabric substrate is coated with a polyolefin composition comprising the following components:
   a1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
   a2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min;
B) 65 to 95 wt.-% based on the overall weight of the polymer composition of a virgin polyolefin composition comprising the following components:
   b1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
   b2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min.

Surprisingly it was found that the specific combination of recycled and virgin material allows the formation of a polymer composition having good mechanical properties.

It will be appreciated that components A and B cannot be the same.

Viewed from another aspect, the invention concerns a process for the preparation of a polymer composition suitable for coating a polyolefin fabric substrate comprising blending the following components:
A) 5 to 35 wt.-% based on the overall weight of the polymer composition of a recycled coated polyolefin fabric substrate; wherein said fabric substrate is coated with a polyolefin composition comprising the following components:
   a1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
   a2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min;
B) 65 to 95 wt.-% based on the overall weight of the polymer composition of a virgin polyolefin composition comprising the following components:
   b1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
   b2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min.

Advantageous embodiments of the polymer composition in accordance with the present invention are specified in the dependent claims.

The present invention further relates to the use of component A) being a recycled coated polyolefin fabric substrate, wherein said fabric substrate is coated with a polyolefin composition comprising the following components:
a1) an ethylene based plastomer with a density in the range of 0.857 to 0.915 g/cm³ and a MFR₂ in the range 0.5 to 30 g/10 min;
a2) a propylene based plastomer with a density in the range of 0.850 to 0.910 g/cm³ and a MFR₂ in the range 0.01 to 30 g/10 min; and

for coating a virgin or recycled polyolefin fabric substrate.

In addition, the invention relates to a process for coating a polyolefin fabric substrate with a polyolefin composition according to the present invention, polyolefin substrates coated with the inventive polymer composition and articles formed from the coated polyolefin substrate.

### DETAILED DESCRIPTION OF INVENTION

### Indications of Quantity

The polymer compositions in accordance with the present invention comprise the components A) and B) and optionally additives. In one embodiment, components A) and B) and if present the additives add up to 100 wt.-% in sum. In this embodiment, this means in case that only components A) and B) are present these components add up to 100 wt.-%. The fixed ranges of the indications of quantity for the individual components A) and B) and optionally the additives are to be understood such that an arbitrary quantity for each of the individual components can be selected within the specified ranges provided that the strict provision is satisfied that the sum of all the components A), B) and optionally the additives add up to 100 wt.-%.

In one embodiment, component A) according to the present invention comprises components a1), a2) and optionally component a3). In one embodiment, the requirement applies here that components a1), a2) and if present component a3) add up to 100 wt.-%. In this embodiment, this means in case that only components a1) and a2) are present these components add up to 100 wt.-%. The fixed ranges of the indications of quantity for the individual components a1), a2) and optionally a3) are to be understood such that an arbitrary quantity for each of the individual components can be selected within the specified ranges provided that the strict provision is satisfied that the sum of all the components a1), a2) and optionally a3) add up to 100 wt.-%.

Component B) according to the present invention comprises components b1), b2) and optionally component b3). In one embodiment, the requirement applies here that components b1), b2) and if present component b) add up to 100 wt.-%. In this embodiment, this means in case that only components b1) and b2) are present these components add up to 100 wt.-%. The fixed ranges of the indications of quantity for the individual components b1), b2) and optionally b3) are to be understood such that an arbitrary quantity for each of the individual components can be selected within the specified ranges provided that the strict provision is satisfied that the sum of all the components b1), b2) and optionally b3) and the additives add up to 100 wt.-%.

For the purposes of the present description and of the subsequent claims, the term coated “recycled” polyolefin fabric substrate is used to indicate that the material is recovered. In the gist of the present invention “recycled coated polyolefin substrates” may also comprise up to 10 wt.-%, preferably up to 5 wt.-% and more preferably up to 1 wt.-% based on the overall weight of the recycled coated polyolefin fabric substrate of other components originating from the first use. Type and amount of these components influence the physical properties of the recycled polymer. Typical other components originating from the first use are constituents of the lacquer such as polyurethanes.

The term “virgin” denotes the newly produced materials and/or objects prior to first use and not being recycled. In case that the origin of the materials is not explicitly mentioned the materials are “virgin” materials.

The term “ethylene based plastomer”, as used herein, refers to a plastomer which comprises a majority amount of polymerized ethylene monomer (based on the weight of the plastomer) and, optionally, may contain at least one comonomer.

The term “propylene based plastomer”, as used herein, refers to a plastomer which comprises a majority amount of polymerized propylene monomer (based on the weight of the plastomer) and, optionally, may contain at least one comonomer.

In the gist of the present invention a “polyolefin fabric substrate” is a fabric substrate which comprises a majority amount of polyolefins (based on the weight of the fabric substrate).

For the purposes of present description and claims a “non-woven” fabric is a fabric or like material that is made from fibres bonded together by chemical, mechanical, heat or solvent treatment. The term is used to denote fabrics, like felt, which are neither woven nor knitted.

For the purpose of the present invention a “flame retardant” is a substance which is activated by the presence of an ignition source and which prevents or slows the further development of ignition by a variety of different physical and chemical methods.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

### Component A)

Component A) of the polymer composition according to the present invention is a recycled coated polyolefin fabric substrate coated with a specific polyolefin composition comprising the components specified below.

Component A) therefore contains at least a polyolefin derived from the polyolefin fabric substrate component; and plastomers a1) and a2) derived from the coating on the polyolefin fabric substrate.

According to a preferred embodiment of the present invention the content of the coating composition is in the range of 5 to 90 wt.-%, preferably in the range of 50 to 85 wt.-%, more preferably in the range of 55 to 75 wt.-% and even more preferably in the range of 60 to 70 wt.-% based on the overall weight of component A).

According to a preferred embodiment of the present invention the content of the fabric substrate is in the range of 8 to 50 wt.-%, preferably in the range of 10 to 45 wt.-%, more preferably in the range of 20 to 35 wt.-% based on the overall weight of component A).

As explained above the polyolefin fabric substrate comprises a majority amount of polyolefins based on the weight of the fabric substrate, preferably the fabric substrate comprises polypropylene and more preferably the substrate consists of polypropylene.

Another embodiment of the present invention stipulates that the fabric substrate used as starting material for component A) is a nonwoven material. According to an alternative embodiment of the present invention the fabric substrate used as starting material for component A) is a woven material. Woven fabrics include knitted fabrics, in particular polypropylene knitted fabrics.

Besides the coating composition as defined herein the polyolefin fabric substrate, the composition used as starting for material for component A) may be further coated with one or more additional materials, such as a lacquer (e.g. a polyurethane lacquer) to modify the surface properties of the polyolefin coated fabric. According to a preferred embodiment of the present invention the content of the lacquer is below 15 wt.-%, preferably in the range of 0.2 to 5 wt.-% and more preferably in the range of 0.4 to 2 wt.-% based on the overall weight of component A).

In general the coated polyolefin fabric substrate can be recycled by any mechanical recycling process known in the art to obtain component A). Preferably said process allows to obtain component A) in shredded form, as pellets, as flakes, as powder or as granules.

The data used in the experimental section of the present invention was generated based on compounded materials. The recycled material was shredded by using the Wittmann mill to get a dosable material for use in the compounds. As such, the shreds were dosed in the twin screw dosing system allowing an accurate control of the feeding amount of the shreds into the extruder.

Another preferred way for recycling the polyolefin fabric substrate is using the Erema Pure Loop system. In this system the fabrics as such (like sheets) are conveyed with a belt to a shredding chamber. The fabrics are then shredded into small pieces, followed by a direct feeding to the extruder for melting, homogeneising, filtering before being pelletized under water. Granules are collected and ready for further use, i.e. compounding.

### Ethylene Based Plastomer

Components A) and B) according to the present invention both comprise an ethylene based plastomer, a1) or b1) respectively. The ethylene based plastomer in both components can be the same or can be different, preferably it is the same. It is not only possible to use a single ethylene based plastomer, but it is also possible to use a mixture of two or more ethylene based plastomers as defined herein. In addition, the ethylene based plastomer may contain standard polymer additives.

Preferred embodiments of the ethylene based plastomer will be discussed in the following.

According to one preferred embodiment of the present invention the ethylene based plastomer a1) and/or b1) is a copolymer of ethylene and at least one C3 to C10 alpha-olefin and preferably is a copolymer of ethylene and 1-octene.

Another preferred embodiment of the present invention stipulates that the ethylene based plastomer a1) and/or b1) has a density determined according to ISO 1183-1 in the range of 0.860 to 0.915 g/cm³, preferably in the range of 0.865 to 0.905 g/cm³ and/or a MFR₂ (190° C., 2.16 kg) determined according to ISO 1133 in the range of 2.5 to 12 g/10 min.

According to a further preferred embodiment of the present invention the content of component a1) in the coating composition of component A) is in the range of 40 to 65 wt.-%, preferably in the range of 45 to 62 wt.-% and more preferably in the range of 52 to 60 wt.-% based on the overall weight of the coating composition of component A).

According to a further preferred embodiment of the present invention the content of component a1) in component A) is in the range of 26 to 43 wt.-%, preferably in the range of 29 to 41 wt.-% and more preferably in the range of 32 to 40 wt.-% based on the overall weight of component A).

According to a further preferred embodiment of the present invention the content of component b1) in component B) is in the range of 40 to 65 wt.-%, preferably in the range of to 62 wt.-% and more preferably in the range of 52 to 60 wt.-% based on the overall weight of component B).

In another preferred embodiment of the present invention the ethylene-based plastomer has an ethylene content in the range of 60 to 95 wt.-%, preferably in the range of 65 to 90 wt.-% and more preferably in the range of 70 to 88 wt.-%. The comonomer contribution preferably is up to 40 wt.-%, such as 5 to 40 wt %, more preferably up to 35 wt.-%.

According to still a further preferred embodiment of the present invention the melting point (measured with DSC according to ISO 11357-3:1999) of the ethylene based plastomer, a1) and/or b1), is below 130° C., preferably below 120° C., more preferably below 110° C. and most preferably below 100° C. A reasonable lower limit for the melting points of suitable ethylene based plastomers is 30° C. A typical melting point range is 33 to 115° C.

Another preferred embodiment of the present invention stipulates that the ethylene based plastomer, a1) and/or b1), has a glass transition temperature Tg (measured with DMTA according to ISO 6721-7) of below −40° C., preferably below −54° C., more preferably below −58° C.

In still another embodiment of the present invention the Mw/Mn value of the ethylene based plastomer, a1) and/or b1), representing the broadness of the molecular weight distribution (MWD), is in the range of 1.5 to 5.0, preferably in the range of 2.0 to 4.5 and more preferably in the range of 2.5 to 4.0.

According to a further embodiment of the present invention the ethylene based plastomer is a metallocene catalysed polymer although Ziegler-Natta based ethylene plastomers are also possible.

Suitable ethylene based plastomers are commercially available, for example from Borealis AG (AT) under the tradename Queo, from DOW Chemical Corp (USA) under the tradename Engage or Affinity, or from Mitsui under the tradename Tafmer.

Methods for manufacturing the ethylene based plastomers are inter alia described in WO2019238943.

### Propylene Based Plastomer

Components A) and B) according to the present invention both comprise a propylene based plastomer. The propylene based plastomer in both components can be the same or can be different, preferably it is the same. It is not only possible to use a single propylene based plastomer, but it is also possible to use a mixture of two or more propylene based plastomers as defined herein. In addition, the propylene based plastomer may contain standard polymer additives.

Where a mixture of plastomers a1) or a mixture of plastomers b1) is used, then the wt % of a1) or b1) refers to the combination of plastomers present. Where a mixture of plastomers a2) or a mixture of plastomers b2) is used, then the wt % of a2) or b2) refers to the weight of the combination of plastomers present.

One preferred embodiment of the present invention stipulates that the propylene based plastomer a2) and/or b2) is a copolymer of propylene and ethylene or a C4 to C10 alpha-olefin.

According to another preferred embodiment of the present invention the propylene based plastomer a2) and/or b2) has a density determined according to ISO 1183-1 in the range of 0.855 to 0.900 g/cm³ and/or a MFR₂ (230° C., 2.16 kg) determined according to ISO 1133 in the range of 3.0 to 22 g/10 min.

In a preferred embodiment of the present invention the content of component a2) in the coating composition of component A) is in the range of 20 to 40 wt.-%, preferably in the range of 29 to 39 wt.-% and more preferably in the range of 30 to 34 wt.-% based on the overall weight of the coating composition of component A).

In a preferred embodiment of the present invention the content of component a2) in component A) is in the range of 6 to 13 wt.-%, preferably in the range of 7 to 12 wt.-% and more preferably in the range of 8 to 11 wt.-% based on the overall weight of component A).

In a preferred embodiment of the present invention the content of component the content of component b2) in component B) is in the range of 20 to 40 wt.-%, preferably in the range of 29 to 39 wt.-% and more preferably in the range of 30 to 34 wt.-% based on the overall weight of component B).

Another preferred embodiment of the present invention stipulates that the propylene based plastomer a2) and/or b2) is a copolymer of propylene and ethylene or a C4 to C10 alpha-olefin.

According to sill a further embodiment of the present invention the propylene based plastomer a2) and/or b2) has a density determined according to ISO 1183-1 in the range of 0.855 to 0.900 g/cm³ and a MFR₂ (230° C., 2.16 kg) determined according to ISO 1133 in the range of 3.0 to 22 g/10 min.

In a further preferred embodiment of the present invention propylene is present in component a2) and/or b2) an amount of 55 to 95 wt.-%. If the comonomer is ethylene, the content of ethylene is preferably 5 to 30 wt.-%, such as 7.5 to 20 wt.-% in the propylene ethylene copolymer.

Still a further preferred embodiment of the present invention stipulates that the propylene based plastomer a2) and/or b2) has a molecular weight distribution(MWD), defined as weight average molecular weight divided by number average molecular weight (Mw/Mn) of 3.5 or less; or 3.0 or less; or from 1.8 to 3.0.

The weight average molecular weight (Mw) of the propylene based plastomers of this invention can vary widely, but typically it is between about 10,000 and 1,000,000 (with the understanding that the only limit on the minimum or the maximum Mw is that set by practical considerations).

Suitable propylene based plastomers of use in the invention are commercially available and can be bought from polymer suppliers. Examples include those available from The Dow Chemical Company, under the trade name VERSIFY, or from ExxonMobil Chemical Company, under the trade name VISTAMAXX.

Methods for manufacturing the ethylene based plastomers are inter alia described in WO2019238943.

Component B) is ideally free of a polyolefin fabric substrate component. In one embodiment, component B) has the same structure as the coating composition of component A).

### Flame Retardant

Components A) and B) according to the present invention both may comprise a flame retardant a3) or b3). The flame retardant in both components can be the same or can be different, preferably it is the same. It is not only possible to use a single flame retardant, but it is also possible to use a mixture of two or more flame retardant as defined herein. Component a3) is ideally part of the coating composition.

According to a preferred embodiment of the present invention the flame retardant a3) or b3) is selected from the group consisting of boron phosphate flame retardants, magnesium oxide, dipentaerythritol, polytetrafluoroethylene (PTFE) polymers, phosphate ester flame retardants (e.g. Tricresyl phosphate); minerals such as aluminium hydroxide (ATH), magnesium hydroxide (MDH), huntite and hydromagnesite, antimony trioxide, alumina trihydrate, red phosphorus, boron compounds, e.g. borates, inorganic phosphinates, metal phosphinates such as salts of phosphinic acids and/or diphosphinic acids or polymeric derivatives thereof, organohalogen compounds such as organochlorines such as chlorendic acid derivatives and chlorinated paraffins, organobromines such as decabromodiphenyl ether (decaBDE), decabromodiphenyl ethane, polymeric brominated compounds such as brominated polystyrenes, brominated carbonate oligomers (BCOs), brominated epoxy oligomers (BEOs), decabromo diphenyl oxide, ethylene bis (tetrabromophthalimide), tetradecabromodiphenoxybenzene, ethylenebis (dibromonorbornanedi-carboximide), tetrabromophthalic anyhydride, tetrabromobisphenol A (TBBPA) and hexabromocyclododecane (HBCD); phosphate salt flame retardants such as metal salts of phosphoric acid, phosphorous acid, hypophosphorous acid, amine phosphate, melamine phosphate, dimelamine phosphate, melamine pyrophosphate, dimelamine pyrophosphate, ammonium polyphosphate, melamine polyphosphate, ethylenediamine phosphate, melamine nitrilotrisphosphonate or a combination thereof, organophosphorus compounds, in particular aromatic phosphates including monophosphates with aromatic groups, di phosphates with aromatic groups, triphosphates with aromatic groups and mixtures thereof.

Other organophosphates include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminium diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

Other known flame retardants which can be used include halogenated and/or melamine based flame retardants as well as those comprising ammonium polyphosphate.

Melamine derivatives include melamine polyphosphate, melamine pyrophosphate and melamine cyanurate, and mixtures of two or more of these materials. The halogenated flame retardants useful in the compositions of the present invention may be selected from organic aromatic halogenated compounds such as halogenated benzenes, biphenyls, phenols, ethers or esters thereof, bisphenols, diphenyloxides, aromatic carboxylic acids or polyacids, anhydrides, amides or imides thereof; organic cycloaliphatic or polycycloaliphatic halogenated compounds; and organic aliphatic halogenated compounds such as halogenated paraffins, oligo- or polymers, alkylphosphates or alkylisocyanurates.

According to a preferred embodiment of the present invention the flame retardant is halogen-free.

Still another preferred embodiment of the present invention stipulates that the flame retardant a3) and/or b3) comprises an ammonium polyphosphate and more preferably consists of an ammonium polyphosphate.

According to a preferred embodiment of the present invention the content of component a3) in the coating composition of component A) is in the range of 5 to 20 wt.-%, preferably in the range of 9 to 16 wt.-% and more preferably in the range of 10 to 14 wt.-% based on the overall weight of the coating composition of component A).

According to a preferred embodiment of the present invention the content of component b3) in component B) is in the range of 5 to 20 wt.-%, preferably in the range of 8 to 16 wt.-% and more preferably in the range of 10 to 14 wt.-% based on the overall weight of component B).

The flame retardant may be added neat or as part of a polymer masterbatch. A polymer masterbatch may contain the flame retardant in a concentration of, for example 2.5 wt.-% to 60% wt.-%.

According to a preferred embodiment of the present invention the flame retardant comprises a mixture of an ammonium polyphosphate and a silane functionalised ethylene copolymer. Ammonium polyphosphates are stable, non-volatile compounds and are commercially available and can be bought from many suppliers. Examples include the ADK STAB FP-2000 series of flame retardants available from Adeka Polymer Additive Europe or IC FR5110 available from Into Chemicals.

The silane functionalised ethylene copolymer is an ethylene copolymer comprising silane group(s) containing units. The silane group(s) containing units can be present as a comonomer of the ethylene copolymer or as a compound grafted chemically to the polymer.

### Additives

The polymer composition according to the present invention may also comprise additives.

According to one preferred embodiment of the present invention the polymer composition comprises at least one additive, preferably selected from the group consisting of slip agents, anti-acids, antimicrobial agents, UV-stabilisers, pigments, antioxidants, antiblock agents, additive carriers, nucleating agents, lubricants, processing aids, silicon-based anti-scratch agents and mixtures thereof. These additives are preferably present in 0.1 to 10 wt.-% and more preferably in 0.5 to 3 wt.-% based on the overall weight of the polymer composition.

### Polymer Composition

Below preferred embodiments of the polymer composition according to the present invention will be discussed.

In a preferred embodiment of the present invention the content of component A) in the polymer composition is in the range of 9 to 31 wt.-% and preferably in the range of 10 to 20 wt.-% based on the overall weight of the polymer composition.

According to another embodiment of the present invention the content of component B) in the polymer composition is in the range of 69 to 91 wt.-% and preferably in the range of 80 to 90 wt.-% based on the overall weight of the polymer composition.

A preferred polymer composition according to the present invention comprises the following components:
A) 5 to 35 wt.-% based on the overall weight of the polymer composition of a recycled coated polyolefin fabric substrate; wherein said fabric substrate is coated with a polyolefin composition comprising the following components:
   a1) 40 to 65 wt.-%, preferably 45 to 62 wt.-% and more preferably 52 to 60 wt.-% based on the overall weight of component a1) of an ethylene based plastomer with a density determined according to ISO 1183-1 in the range of 0.860 to 0.915 g/cm³ and a MFR₂ (190° C., 2.16 kg) determined according to ISO 1133 in the range of 0.5 to 30 g/10 min;
a2) 20 to 40 wt.-%, preferably 29 to 39 wt.-%, more preferably 30 to 34 wt.-% based on the overall weight of component a2) of a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min; and
   a3) 5 to 20 wt.-%, preferably 9 to 16 wt.-% and more preferably 10 to 14 wt.-% based on the overall weight of component a3) of a flame retardant, preferably an ammonium polyphosphate;
B) 65 to 95 wt.-% based on the overall weight of the polymer composition of a virgin polyolefin composition comprising the following components:
   b1) 40 to 65 wt.-%, preferably 45 to 62 wt.-% and more preferably 52 to 60 wt.-% based on the overall weight of component b1) of an ethylene based plastomer with a density determined according to ISO 1183-1 in the range of 0.860 to 0.915 g/cm³ and a MFR₂ (190° C., 2.16 kg) determined according to ISO 1133 in the range of 0.5 to 30 g/10 min;
   b2) 20 to 40 wt.-%, preferably 29 to 39 wt.-%, more preferably 30 to 34 wt.-% based on the overall weight of component b2) of a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min; and
   b3) 5 to 20 wt.-%, preferably 9 to 16 wt.-% and more preferably 10 to 14 wt.-% based on the overall weight of component b3) of a flame retardant, preferably an ammonium polyphosphate.

In one embodiment, components a1), a2) and a3) of component A) add up to 100 wt.-%.

In one embodiment, components A) and B) add up to 100 wt.-%.

A preferred polymer composition according to the present invention comprises the following components:
A) 9 to 31 wt.-%, preferably 10 to 20 wt.-% based on the overall weight of the polymer composition of a recycled coated polyolefin fabric substrate; wherein said fabric substrate is coated with a polyolefin composition comprising the following components:
   a1) 40 to 65 wt.-%, preferably 45 to 62 wt.-% and more preferably 52 to 60 wt.-% based on the overall weight of component a1) of an ethylene based plastomer with a density determined according to ISO 1183-1 in the range of 0.865 to 0.905 g/cm³ and a MFR₂ (190° C., 2.16 kg) determined according to ISO 1133 in the range of 2.5 to 12 g/10 min;
   a2) 20 to 40 wt.-%, preferably 29 to 39 wt.-%, more preferably 30 to 34 wt.-% based on the overall weight of component a2) of a propylene based plastomer with a density determined according to ISO 1183-1 in the range of 0.855 to 0.900 g/cm³ and a MFR₂ (230° C., 2.16 kg) determined according to ISO 1133 in the range of 3 to 22 g/10 min; and
   a3) 5 to 20 wt.-%, preferably 9 to 16 wt.-% and more preferably 10 to 14 wt.-% based on the overall weight of component a3) of a flame retardant, preferably an ammonium polyphosphate;
B) 69 to 91 wt.-%, preferably 80 to 90 wt.-% based on the overall weight of the polymer composition of a virgin polyolefin composition comprising the following components:
   b1) 40 to 65 wt.-%, preferably 45 to 62 wt.-% and more preferably 52 to 60 wt.-% based on the overall weight of component b1) of an ethylene based plastomer with a density determined according to ISO 1183-1 in the range of 0.865 to 0.905 g/cm³ and a MFR₂ (190° C., 2.16 kg) determined according to ISO 1133 in the range of 2.5 to 12 g/10 min;
   b2) 20 to 40 wt.-%, preferably 29 to 39 wt.-%, more preferably 30 to 34 wt.-% based on the overall weight of component b2) of a propylene based plastomer with a density determined according to ISO 1183-1 in the range of 0.855 to 0.900 g/cm³ and a MFR₂ (230° C., 2.16 kg) determined according to ISO 1133 in the range of 3 to 22 g/10 min; and
   b3) 5 to 20 wt.-%, preferably 9 to 16 wt.-% and more preferably 10 to 14 wt.-% based on the overall weight of component b3) of a flame retardant, preferably an ammonium polyphosphate.

The composition of the invention may be prepared by any suitable method. Ideally, a method is used which produces a homogenous mixture of the various components. Typically, compounding is employed. Compounding usually involves mixing or/and blending the various components in a molten state, often by extrusion.

In one embodiment, the polymer composition is prepared by obtaining a recycled coated polyolefin fabric substrate as hereinbefore defined and shredding the same to form shreds; combining, optionally in an extruder,
A) 5 to 35 wt.-% based on the overall weight of the polymer composition of a recycled coated polyolefin fabric substrate; wherein said fabric substrate is coated with a polyolefin composition comprising the following components:
   a1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
   a2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min; and
B) 65 to 95 wt.-% based on the overall weight of the polymer composition of a virgin polyolefin composition comprising the following components:
   b1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
   b2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min.

In one embodiment, the shreds can be extruded and pelletized before combination with the component B). In one embodiment, the polymer composition of the invention can be pelletised in the extruder.

### Use of Component A)

The present invention also relates to the use of component A) being a recycled coated polyolefin fabric substrate, wherein said fabric substrate is coated with a polyolefin composition comprising the following components:
a1) an ethylene based plastomer with a density in the range of 0.857 to 0.915 g/cm³ and a MFR₂ in the range 0.5 to 30 g/10 min;
a2) a propylene based plastomer with a density in the range of 0.850 to 0.910 g/cm³ and a MFR₂ in the range 0.01 to 30 g/10 min; and

for coating a virgin or recycled polyolefin fabric substrate.

Preferred embodiments of the use of component A) in accordance with the present invention will be explained below.

A preferred embodiment according to the present invention stipulates that component A) comprises a3) a flame retardant, preferably an ammonium polyphosphate and more preferably consists of an ammonium polyphosphate.

According to another preferred embodiment of the present invention the coating of the virgin or recycled coated polyolefin fabric substrate comprises 5 to 35 wt.-% of component A) and 65 to 95 wt.-% based on the overall weight of the coating of component B) being a virgin polyolefin composition comprising the following components:
b1) an ethylene based plastomer with a density in the range of 0.857 to 0.915 g/cm³ and a MFR₂ in the range 0.5 to 30 g/10 min;
b2) a propylene based plastomer with a density in the range of 0.850 to 0.910 g/cm³ and a MFR₂ in the range 0.01 to 30 g/10 min; and
b3) optionally a flame retardant.

The use according to the present invention allows the reuse of the recycled coated polyolefin fabric substrate, optionally in combination with another material, for example for coating virgin polyolefin fabric substrates. This means the recycled coated polyolefin fabrics can be reused for the same application than during its first use.

In a further preferred embodiment of the present invention component A) is used in shredded form, as pellets, as flakes, as powder or as granules.

Still a further preferred embodiment of the present invention stipulates that the coating of the polyolefin fabric substrate, preferably being a virgin polyolefin fabric substrate, is conducted by simultaneous feeding of components A) and B) in a coating line; preferably the coating is conducted by calendaring, extrusion coating or lamination.

The virgin or recycled polyolefin fabric substrate to be coated may be one that comprises a majority amount of polyolefins based on the weight of the fabric substrate, preferably the fabric substrate comprises polypropylene and more preferably the substrate consists of polypropylene.

All preferred aspects and embodiments as described above shall also hold for the use according to the present invention.

### Applications

The polymer composition according to the invention may be used to coat a substrate, such as a polyolefin fabric substrate. Thus, a further aspect of the present invention relates to a polyolefin fabric substrate coated with the polyolefin composition in accordance with the present invention.

A preferred polyolefin fabric substrate is a woven or non-woven fabric and preferably is a knitted fabric.

In addition, the invention also relates to a process for coating a polyolefin fabric substrate with a polyolefin composition in accordance with the present invention, said process comprising applying said composition to the surface of said polyolefin fabric substrate.

Preferably the fabric substrate comprises polypropylene and more preferably the substrate consists of polypropylene.

Besides the coating composition as defined herein the polyolefin fabric substrate may be further coated with one or more additional materials, such as a lacquer (e.g. a polyurethane lacquer) to increase scratch resistance and reduce transfer of the coatings to clothing, for example.

According to one preferred embodiment of the present invention, the fabric substrate comprises a material of a weight of from 100 to 500, more typically of from 150 to 400 and even more typically of from 200 to 350, grams per square meter (g/m²). In one embodiment, the fabric substrate is prepared from polyethylene or polypropylene, preferably from polyethylene.

The composition in accordance with the present invention may be applied to the polyolefin fabric substrate in any suitable way known in the art, for example by extrusion, calendaring using, for example, a roller system, lamination and knife coating (after dissolution of the composition in water with additives).

The invention also relates to an article comprising at least one component formed from the coated polyolefin substrate according to the present invention, which is preferably selected from the group consisting of office furniture, vehicle interiors, seat cushions, back rest cushions, pillows, upholstered furniture, bed matresses, wall coverings, clothing, shoes, preferably tongue, vamp, heel counter, quarter, sports bags, inlay of sky boots, sports equipment, preferably boxing gloves, boxing balls, carpets, rubber boats, swimming pools, life vests, handbags, purses, table coverings, table mats, stationary, preferably books and wood inlay, saddlebags, tool bags.

The invention will now be described with reference to the following non-limiting examples and FIGURES.

### BRIEF DESCRIPTION OF THE FIGURES

FIGS. 1a-c, 2a-c and 3a-c show the FTIRs for blue, white and black recycled coated polyolefin fabric substrate.

### Experimental Part

### A. Measuring Methods

The following definitions of terms and determination methods apply for the above general description of the invention as well as to the below examples unless otherwise defined.

### Melt Flow Rate

The melt flow rate (MFR) was determined according to ISO 1133-Determination of the melt mass-flow rate (MFR) and melt volume-flow rate (MVR) of thermoplastics—Part 1: Standard method and is indicated in g/10 min. The MFR is an indication of the flowability, and hence the processability, of the polymer. The higher the melt flow rate, the lower the viscosity of the polymer. The MFR₂ of polyethylene-based plastomers is determined at a temperature of 190° C. and a load of 2.16 kg. The MFR₂ of polypropylene-based plastomers is determined at a temperature of 230° C. and a load of 2.16 kg.

### Density

Density of the materials was measured according to ISO 1183-1. Sample preparation is done by compression moulding in accordance with ISO 1872-2.

### Tensile Modulus, Tensile Strength, Tensile Strain at Break, Tensile Strain at Tensile Strength, Tensile Stress at Break

The measurements were conducted after 96 h conditioning time (at 23° C. at 50% relative humidity) of the test specimen. The specimen was prepared by stamping (punched/cut) out of the injection moulded plaque, and the tensile tests were conducted at 23° C. according to ASTM D638-type 4.

Tensile Modulus was determined at a tensile speed of 0.6 mm/min. All other parameters (Tensile Strength, Tensile Strain at Break, Tensile Strain at Tensile strength, Tensile Stress at Break and Tensile Stress at Yield) were determined at a tensile speed of 5 mm/min, until break.

Glow wire and LOI measurements are based on specimens (plaques) prepared by compression-moulding according to ISO 29 (Collin R 1358, edition: 2/060510) The plaques have a surface area of 140×150 mm and a thickness of 1 mm and 3 mm.

### Limited Oxygen Index (LOI)

LOI (Stanton Redcroft from Rheometric Scientific) was performed by following ASTM D2863-17a. The plaques prepared as described above were placed in a climate room with relative humidity 50±5% and temperature 23° C. for at least 24 hours prior to the test. Ten sample rods having length 135 mm, width 6.5 mm and thickness of 3 mm were punched from a plaque. A single sample rod was placed vertically in a glass chimney with a controlled atmosphere of oxygen and nitrogen that had been flowing through the chimney for at least 30 seconds and then ignited by an external flame on the top. If the sample had a flame present after three minutes or if the flame had burned down more than 50 mm, the test failed. Different oxygen concentrations were tested until a minimum oxygen level was reached where the sample passed the test and the flame was extinguished before three minutes or 50 mm.

### Glow Wire Test

The glow wire test was conducted according to IEC60695-1-30:2008 IEC60695-2-10:2000 IEC60695-2-13 Part 2-13. The glow-wire test is a test procedure to simulate the effects of thermal stresses which may be produced by heat sources such as glowing elements or overloaded resistors in order to assess the fire hazards by simulation technique. The test procedure is a small-scale test in which an electrically heated wire is used as a source of ignition on a series of standard test specimens to determine the glow-wire flammability index, GWFI and the glow-wire ignitability index, GWIT. GWFI is the highest temperature at which the tested material:
a) does not ignite or, if it does, extinguishes within 30 seconds after removal of the glow wire and is not totally consumed, or
b) molten drips, if they occur, do not ignite the wrapping tissue.

GWIT is the temperature which is 25° C. higher than the maximum test temperature at which the tested material:
a) does not ignite, or
b) if sustained and continuous flaming combustion does not occur for a time longer than seconds for any single flame event and the specimen is not totally consumed.

### Materials Used

### Component A): Recycled Coated Polyolefin Fabric Substrate

Coated polyolefin fabric substrates in sheet form were shredded by using a Wittmann mill at ambient temperature into small pieces which are about the same size of a standard polymer pellet. The used polyolefin fabric substrate is a PP-based knitted fabric having on top 2 thin layers (thickness approx . . . 0.09 mm and 0.4 mm), each comprising the coating composition as defined in Table 1, as well as lacquers in the amounts as specified below. The lacquers are consisting of other non-polyolefin based resins, mainly polyurethane and polyacrylate.

Recycled coated polyolefin fabric substrates were subjected to analysis via FTIR. FTIR analysis of three recycled coated polyolefin fabric substrates (the same other than in colour) showed that all 3 samples are 3-layer structures comprising:
Urethane and/or silicon based resins in the lacquer layer
EPR, PE plastomer in the coating layer
PP-homopolymer in the fabric substrate

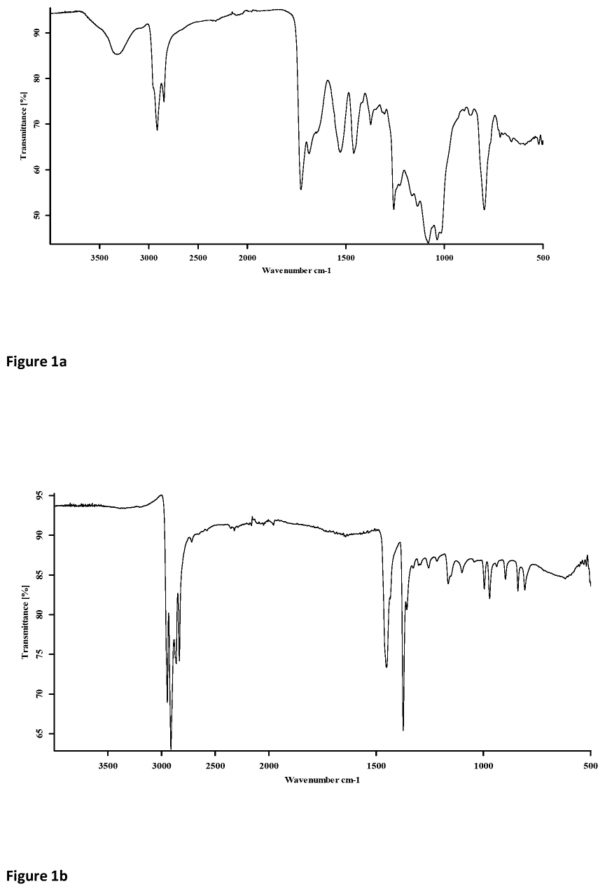

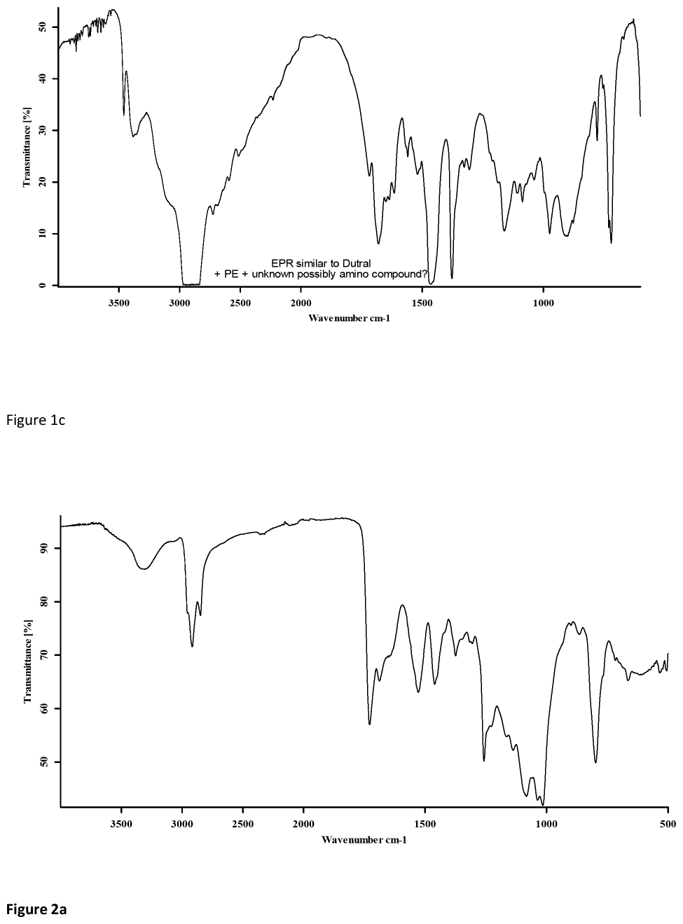

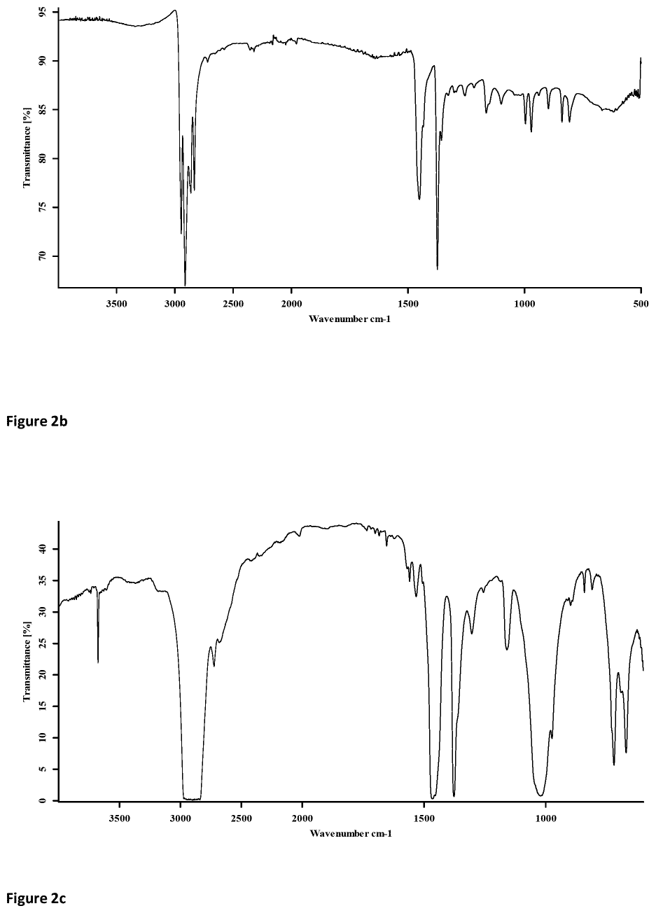

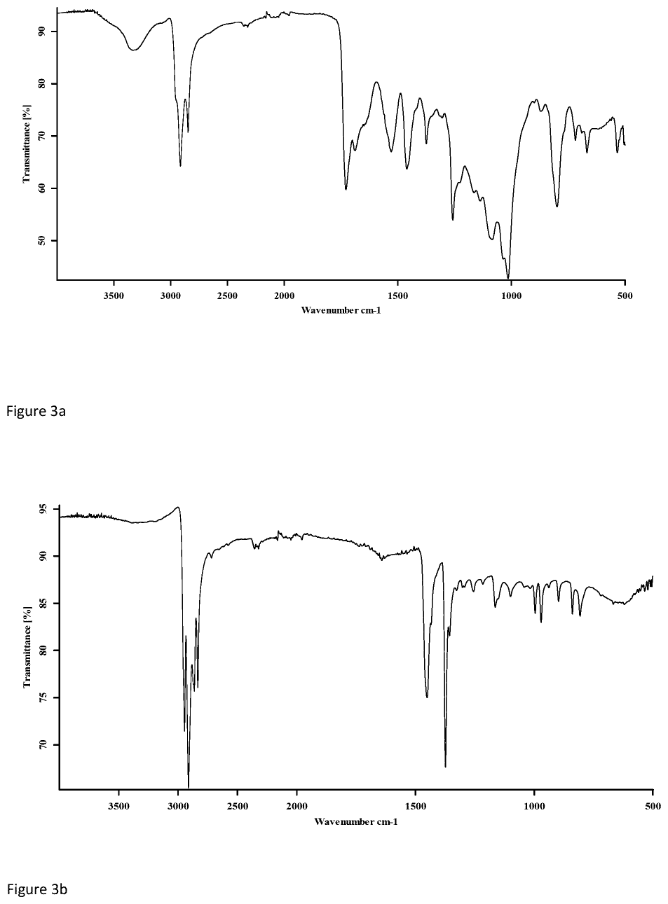

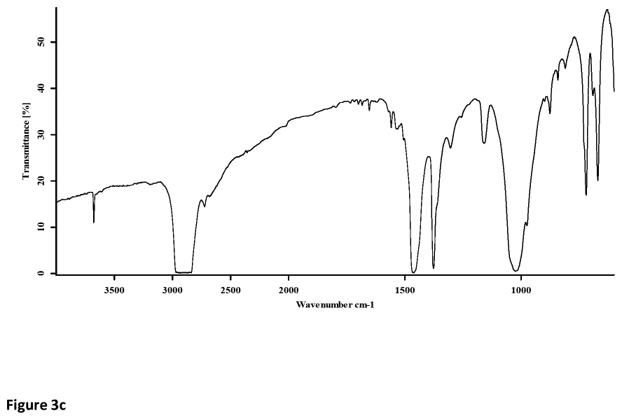

FIGS. 1a-c, 2a-c and 3a-c show the FTIRs for blue, white and black recycled coated polyolefin fabric substrate.

Lacquer: 5.0 wt.-% based on the total weight of the coated polyolefin fabric substrate Coating composition: 65 wt.-% based on the total weight of the coated polyolefin fabric substrate

Polypropylene fabric: 30 wt.-% based on the total weight of the coated polyolefin fabric substrate (thickness: 0.5 mm)

TABLE 1
Composition of the coating of the recycled polyolefin fabric substrate.

| Content | | |
|---|---|---|
| [wt.-%] | Description | Tradename/Supplier |
| 45.8 | Ethylene based plastomer: an ethylene octene | Queo 7007LA/ |
| | metallocene plastomer, density = 0.870 g/cm³, | Borealis AG |
| | MFR₂ (190° C./2.16 kg) = 6.6 g/10 min | |
| | (=component a1) | |
| 11.0 | Ethylene based plastomer: an ethylene octene | Queo 0203/ |
| | metallocene plastomer, density = 0.902 g/cm³, | Borealis AG |
| | MFR₂ (190° C./2.16 kg) = 3 g/10 min | |
| | (=component a1) | |
| 31.45 | Random propylene ethylene metallocene | Vistamaxx 6202/ |
| | plastomer, density = 0.862 g/cm³, MFR2 (230° C., | Exxon Mobile |
| | 2.16 kg) = 20 g/10 min (=component a2) | |
| 11.0 | Ammonium polyphosphate (flame retardant = | ADKSTAB FP2500S/ |
| | component a3) | ADEKA Polymer |
| | | Additives Europe |
| 0.75 | Stabilizer mixture comprising UV-stabilizers and | — |
| | antioxidants | |

### Component (B): Virgin Flame-Retardant Polyolefin Composition

The virgin flame-retardant polyolefin composition used in the Working Examples comprises the components summarized in below Table 2.

TABLE 2
Composition of the virgin flame-retardant polyolefin composition (B).

| Content | | |
|---|---|---|
| [wt.-%] | Description | Tradename/Supplier |
| 45.8 | Ethylene based plastomer: an ethylene octene | Queo 7007LA/ |
| | metallocene plastomer, density = 0.870 g/cm³, | Borealis AG |
| | MFR₂ (190° C./2.16 kg) = 6.6 g/10 min | |
| | (=component b1) | |
| 11.0 | Ethylene based plastomer: an ethylene octene | Queo 0203/ |
| | metallocene plastomer, density = 0.902 g/cm³, | Borealis AG |
| | MFR₂ (190° C./2.16 kg) = 3 g/10 min | |
| | (=component b1) | |
| 31.45 | Random propylene ethylene metallocene | Vistamaxx 6202/ |
| | plastomer, density = 0.862 g/cm³, MFR₂ (230° C., | Exxon Mobile |
| | 2.16 kg) = 20 g/10 min (=component b2) | |
| 11.0 | Ammonium polyphosphate (flame retardant = | ADKSTAB FP2500S/ |
| | component b3) | ADEKA Polymer |
| | | Additives Europe |
| 0.75 | Stabilizer mixture comprising UV-stabilizers and | — |
| | antioxidants | |

### B. Manufacturing of the Polymer Composition

The polymer compositions according to the Inventive Examples IE1 to IE3 were manufactured by feeding component A) into a co-rotating twin screw side feeder (extruder prism TSE 24MC) which allowed an accurate feeding and dosing of the material into the extruder. Component B was fed in the form of granules into the same extruder via the main hopper. In the extruder components A) and B) were melt blended (230° C., output rate 6 kg/hour) and subsequently pelletized by an underwater cooling system. The obtained pellets were collected, dried and submitted tested. The materials according to CE1 and CE3 were not compounded. The amounts of the different components in the polymer compositions and the properties of the polymer compositions according to the inventive examples and the comparative examples can be gathered from below Table 3.

TABLE 3
Composition and properties of the polymer compositions.

| | Unit | IE1 | IE2 | IE3 | CE1 | CE2 |
|---|---|---|---|---|---|---|
| Component | | | | | | |
| virgin PO composi- | wt.-% | 90 | 80 | 70 | 100 | — |
| tion (B) | | | | | | |
| Recycled coated | wt.-% | 10 | 20 | 30 | — | 100 |
| polyolefin fabric | | | | | | |
| substrate (A) | | | | | | |
| Properties | | | | | | |
| MFR₂ | g/10 min | 6.4 | 7.5 | 8.2 | 5.6 | n.d. |
| Tensile Modulus | MPa | 24.0 | 36.0 | 49.0 | 20.0 | 266 |
| Tensile Strength | MPa | 12.2 | 10.9 | 9.6 | 13.0 | 9.3 |
| Tensile Strain at | % | 1158 | 978 | 801 | 1191 | 358 |
| Tensile Strength | | | | | | |
| Tensile Stress at | MPa | 12.0 | 10.8 | 9.4 | 12.9 | 9.1 |
| Break | | | | | | |
| Tensile Strain at | % | 1158 | 978 | 801 | 1191 | 360 |
| Break | | | | | | |
| LOI | % | 25.5 | 24.5 | 25.0 | 26.0 | 20.5 |

Glow Wire test for specimens
60 × 60 × 3 mm

| | | | | | | |
|---|---|---|---|---|---|---|
| GWFI | ° C. | 825 | 825 | 850 | 850 | 825 |
| GWIT | ° C. | 850 | 850 | 875 | 875 | 850 |

Glow Wire test for specimens
60 × 60 × 1 mm

| | | | | | | |
|---|---|---|---|---|---|---|
| GWFI | ° C. | 875 | 875 | 875 | 875 | 875 |
| GWIT | ° C. | 900 | 900 | 900 | 900 | 900 |

n.d. = not determined.

### D. Discussion of the Results

As can be gathered from Table 3 a polymer composition comprising 10 wt.-% or 20 wt.-% component (A) (=recycled material) still shows very good tensile properties (see low values for inventive examples IE1 and IE2). Even a polymer composition comprising 30 wt.-% of component (A) shows acceptable tensile properties. The polymer composition according to the inventive examples and CE1 (virgin PO composition) are at the same LOI-level and clearly above that of the recycled polyolefin fabric (CE2). The Glow Wire test shows comparable values between the polyolefin compositions according to the invention (IE to IE3) and the comparative examples (CE1 and CE2). Thus, the experimental trials show that the use of recycled materials is not deteriorating the flame retardance behaviour.

1. A polymer composition suitable for coating a polyolefin fabric substrate comprising the following components:
A) 5 to 35 wt.-% based on the overall weight of the polymer composition of a recycled coated polyolefin fabric substrate; wherein said fabric substrate is coated with a polyolefin composition comprising the following components:
a1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
a2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min;
B) 65 to 95 wt.-% based on the overall weight of the polymer composition of a virgin polyolefin composition comprising the following components:
b1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
b2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min.

2. The polymer composition according to claim 1, wherein the content of the coating composition in component A) is in the range of 5 to 90 wt.-% based on the overall weight of component A).

3. The polymer composition according to claim 1, characterized in that:
the ethylene based plastomer a1) and/or b1) is a copolymer of ethylene and at least one C3 to C10 alpha-olefin;
the propylene based plastomer a2) and/or b2) is a copolymer of propylene and ethylene or a C4 to C10 alpha-olefin;
or a combination thereof.

4. The polymer composition according to claim 1, characterized in that:
the ethylene based plastomer a1) and/or b1) has a density determined according to ISO 1183-1 in the range of 0.860 to 0.915 g/cm³ and/or a MFR₂ (190° C., 2.16 kg) determined according to ISO 1133 in the range of 2.5 to 12 g/10 min;
the propylene based plastomer a2) and/or b2) has a density determined according to ISO 1183-1 in the range of 0.855 to 0.900 g/cm³ and/or a MFR₂ (230° C., 2.16 kg) determined according to ISO 1133 in the range of 3.0 to 22 g/10 min;
or a combination thereof.

5. The polymer composition according to claim 1, characterized in that:
a1) and b1) have the same chemical composition, and
a2) and b2) have the same chemical composition.

6. The polymer composition according to claim 1, characterized in that component A) further comprises a flame retardant a3), component B) further comprises a flame retardant b3), or a combination thereof.

7. The polymer composition according to claim 6, characterized in that:
the content of component a1) in the coating composition of component A) is in the range of 40 to 65 wt.-% based on the overall weight of the coating composition of component A);
the content of component a2) in the coating composition of component A) is in the range of 20 to 40 wt.-% based on the overall weight of the coating composition of component A); and/or
the content of component a3) in the coating composition of component A) is in the range of 5 to 20 wt.-% based on the overall weight of the coating composition of component A);
or a combination thereof.

8. The polymer composition according to claim 6, characterized in that:
the content of component b1) in component B) is in the range of 40 to 65 wt.-% based on the overall weight of component B);
the content of component b2) in component B) is in the range of 20 to 40 wt.-% based on the overall weight of component B);
the content of component b3) in component B) is in the range of 5 to 20 wt.-% the overall weight of component B);
or a combination thereof.

9. The polymer composition according to claim 1, characterized in that:
the content of component A) in the polymer composition is in the range of 9 to 31 wt.-% based on the overall weight of the polymer composition; and/or
the content of component B) in the polymer composition is in the range of 69 to 91 wt.-% based on the overall weight of the polymer composition;
or a combination thereof.

10. The polymer composition according to claim 1, characterized in that polymer composition component A) is in shredded form, as pellets, as flakes, as powder, or as granules.

11. The polymer composition according to claim 1, characterized in that the polymer composition comprises at least one additive present in 0.1 to 10 wt.-% based on the overall weight of the polymer composition.

12. A process for the preparation of a polymer composition suitable for coating a polyolefin fabric substrate, the process comprising blending the following components:
A) 5 to 35 wt.-% based on the overall weight of the polymer composition of a recycled coated polyolefin fabric substrate; wherein said fabric substrate is coated with a polyolefin composition comprising the following components:
a1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
a2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min;
B) 65 to 95 wt.-% based on the overall weight of the polymer composition of a virgin polyolefin composition comprising the following components:
b1) an ethylene based plastomer with a density determined according to ISO 1183-1 in the range of 0.857 to 0.915 g/cm³ and a MFR₂ (190° C., 2.16 kg) determined according to ISO 1133 in the range of 0.5 to 30 g/10 min; and
b2) a propylene based plastomer with a density determined according to ISO 1183-1 in the range of 0.850 to 0.910 g/cm³ and a MFR₂ (230° C., 2.16 kg) determined according to ISO 1133 in the range of 0.01 to 30 g/10 min.

13. A method of use of component A) for coating a virgin or recycled polyolefin fabric substrate, component A) being a recycled coated polyolefin fabric substrate, wherein said fabric substrate is coated with a polyolefin composition comprising the following components:
a1) an ethylene based plastomer with a density in the range of 0.857 to 0.915 g/cm³ and a MFR₂ in the range 0.5 to 30 g/10 min; and
a2) a propylene based plastomer with a density in the range of 0.850 to 0.910 g/cm³ and a MFR₂ in the range 0.01 to 30 g/10 min.

14. The method of use according to claim 13, characterized in that the coating of the virgin or recycled polyolefin fabric substrate comprises:
5 to 35 wt.-% of component A) and
65 to 95 wt.-% based on the overall weight of the coating of component B),
component B) being a virgin polyolefin composition comprising the following components:
b1) an ethylene based plastomer with a density in the range of 0.857 to 0.915 g/cm³ and/or a MFR₂ in the range 0.5 to 30 g/10 min;
b2) a propylene based plastomer with a density in the range of 0.850 to 0.910 g/cm³ and/or a MFR₂ in the range 0.01 to 30 g/10 min; and
b3) optionally a flame retardant.

15. The method of use according to claim 13, characterized in that component A) further comprises a3) a flame retardant.

16. The method of use according to claim 13, characterized in that component A) is used in shredded form, as pellets, as flakes, as powder, or as granules.

17. The method of use according to claim 13, characterized in that the coating of the polyolefin fabric substrate is conducted by simultaneous feeding of components A) and B) in a coating line.

18. A process for coating a polyolefin fabric substrate with the polyolefin composition as defined in claim 1, said process comprising applying said composition to the surface of said polyolefin fabric substrate.

19. A polyolefin fabric substrate coated with the polyolefin composition as defined in claim 1.

20. The polyolefin fabric substrate according to claim 19, wherein the fabric substrate is a woven or non-woven fabric.

21. An article comprising at least one component formed from the coated polyolefin substrate as defined in claim 19, wherein the article is selected from the group consisting of office furniture, vehicle interiors, seat cushions, back rest cushions, pillows, upholstered furniture, bed mattresses, wall coverings, clothing, shoes, preferably tongue, vamp, heel counter, quarter, sports bags, inlay of sky boots, sports equipment, preferably boxing gloves, boxing balls, carpets, rubber boats, swimming pools, life vests, handbags, purses, table coverings, table mats, stationary, preferably books and wood inlay, saddlebags, and tool bags.
